(19) United States
(12) Patent Application Publication
(10) Pub. No.: US 2007/0143678 A1
(43) Pub. Date: Jun. 21, 2007

(54) Method and apparatus for persistently resolving events to event source

(76) Inventor: Barry Alan Feigenbaum, Austin, TX (US)

Correspondence Address: IBM CORP. (MRN);c/o LAW OFFICE OF MICHAEL R. NICHOLS, 3001 S. HARDIN BLVD., STE. 110, PMB 155, MCKINNEY, TX, 75070-7702, US

(21) Appl. No.: 11/315,383

(22) Filed: Dec. 21, 2005

(51) Int. Cl. G06F 9/00

(52) U.S. Cl. 715/704

(57) ABSTRACT

A method, computer program product, and data processing system for recording GUI events and for persistently identifying the events' target GUI components for subsequent playback of the recorded events are disclosed. According to a preferred embodiment of the invention, each GUI component is assigned a numerical identifier by traversing the component hierarchy in a well-defined order. As the GUI components are visited during the traversal, the components are numbered sequentially according the order in which the components were visited. When events are received, they are recorded along with the number corresponding to the target component of the event. Upon a subsequent execution of the GUI program, the hierarchy is traversed again in the same order, which results in the same assignment of identifying numbers to components. Therefore, the recorded events may be played back by applying each event to its corresponding target component, as identified by number.

### BACKGROUND OF THE INVENTION

1. Technical Field

The present invention relates generally to the field of object-oriented graphical user interfaces (GUIs). More specifically, the present invention provides a method, computer program product, and data processing system for recording and replaying events in an event-driven object-oriented graphical user interfaces (GUIs).

2. Description of the Related Art

The earliest interactive computers relied on tele-typewriter (TTY) or text terminals for interactive communication with a human operator. These early forms of human-computer interaction (HCI) allowed for only text- or character-based information exchange. Many computer software products today utilize a graphical user interface or GUI (typically pronounced like “gooey”). A GUI is visual means of human-computer interaction that utilizes pictures or other visual representations besides text or characters.

Most GUIs make use of visual controls that are displayed on the user's display and actuated by user input. Typical visual controls include, but are not limited to, buttons, text fields (for entering text), radio buttons, checkboxes, selection boxes, and menu bars. In a typical GUI, a pointing device, such as a mouse, is used to move a cursor around a display and actuate visual controls. GUIs usually also make use of static display components, such as labels and icons, which are intended to be displayed, but generally have no input function, per se. Sometimes these static display components may serve an input role, however, when they are moved around on the display relative to other features on the display (e.g., dragging an icon of a file to a trash can icon to delete a file, for example).

Many GUIs are what is known as a “windowing” interface, because they arrange information visually on a display in the form of panels or “windows” superimposed on a background called a “desktop.” In many systems, windows may be dragged to different locations on the display with a pointing device, enlarged, reduced, made to overlap with other windows. Typically, a window will contain a number of visual controls to allow a user to interact with a computer program by actuating the controls in the window. A special form of window, known as a “dialog box,” is displayed by a program when some input is required from a user.

Windows, visual controls, and static display components are what are known as GUI components, because they are the building blocks that make up the GUI. Some GUI components, such as windows, are known as “container components” (or simply “containers”), because they may contain other components. For example, a window may contain visual controls, such as a button or menu bar, and static display components, such as text labels or icons. A container may also contain another container. For example, in some windowing-based word processors, the word processor itself occupies a (main) window, while each file under editing occupies another window within the main window.

Container components include windows, but may also include other components, which may be visible or invisible. For example, the JAVA™ programming language produced by Sun Microsystems, Inc. of Mountain View, Calif., defines various visible container components, such as windows and dialog boxes, as well as invisible container components, such as the “java.awt.Panel” container component, which is used solely to group a number of contained components into a single unit. Some examples of containers include, but are not limited to, windows, dialog boxes, panels, tabbed panels, notebook pages, and any other GUI components that have a capability of containing one or more other GUI components.

The actual functionality for providing basic operations on GUI components, such as displaying the components or detecting user input directed at the components (e.g., from pointing at or clicking on a component with a pointing device), is often provided by system-level software, such as an operating system. Generally speaking, applications will issue calls to system-level software for creating and maintaining GUIs, while the system-level software detects user input events that are directed at particular GUI components and sends event notifications to the applications that are responsible for those GUI components.

For example, the WINDOWS® operating system produced by Microsoft, Inc. of Redmond, Wash. provides services for the creation of GUIs and relaying of user input events to appropriate applications. The main interface for the WINDOWS® operating system itself is a GUI as well. In other settings, higher-level system software may operate on top of an operating system kernel (e.g., as a daemon or background process) to provide GUI services. For example, “X11” is an open-source GUI engine that operates as a process in an operating system. X11 adopts a client-server model in that an X11 server process accepts requests from applications (clients) for providing GUI services and relays user input events that pertain to particular GUI components to the applications associated with those components.

Alternatively, an application may contain its own code for providing GUI services. Typically, this code will come in the form of a reusable code library for performing basic GUI operations.

Many modern programming language implementations have built-in features for producing GUIs, usually either by providing an interface to GUI services provided by system-level software or by including libraries of low-level GUI code for which an interface in the programming language is provided. The JAVA™ programming language, for example, is an object-oriented programming language that includes standard application programming interfaces (APIs) for defining GUIs. Two APIs that are currently part of the JAVA™ programming language standard are the Abstract Windowing Toolkit (AWT) API and the Swing API (which is built on the AWT API). In the JAVA™ programming language, as is typical of object-oriented GUI APIs, each type of GUI component is defined as a class.

In an object-oriented programming language, a class is a definition of a data type that includes a collection of data, called member variables, and a set of operations that may be performed on the data, called methods (or alternatively, member functions). An actual collection of data in the data type defined by a class is called an object. In object-oriented programming (OOP) parlance, an object is said to be an “instance” of the class, because it is a data structure that is defined in accordance with the class. The run-time process of generating an object in an object-oriented programming language is called “instantiation,” and an object that exists at run-time is said to be “instantiated.”

Object-oriented programming languages also typically provide for what is known as “inheritance.” Using an inheritance a new class (called a “descendant” class) can be defined in terms of one or more existing classes (called “base” classes) so that the descendant class inherits one or more of the member variables or methods of the base class. For example, in the JAVA™ programming language's AWT API, “Container” is a descendant class of a base class called “Component,” the “Container” class will include at least some of the methods and member variables of “Container.” We thus say that “Container” is descended from “Component.” In many cases, a descendant class will include additional methods or member variables that are not inherited from the base class.

Also, a descendent class may be written so as to override the base class's code for a particular method. For example, the base class “Container” may have a method called “show,” for displaying a GUI component, which the descendant class “Container” inherits. Since displaying a container (which may contain other components) is more specific than displaying a generic GUI component, the “Container” class may define different code for “show” than that of the “Component” class.

This is important, since in most object-oriented languages, an object in a descendant class is treated as being a more specific instance of the base class. Thus, a “Container” object may be stored in a variable of type “Component,” or a method that takes a “Component” as an argument can also take a “Container” as an argument, since a “Container” will inherit characteristics (i.e., member variables and methods) from “Component.” This ability to treat objects from descendant classes as if they were instances of base classes is called “polymorphism.”

In an object-oriented GUI API, such as those provided by the JAVA™ programming language, GUI components are instantiated as objects, and relationships are established between the instantiated objects in order to define the placement and behavior of GUI components with respect to each other. For example, a “containment relation” is a relationship between GUI components that relates a container component to the components contained by that container component. In the JAVA™ programming language, for example, a component typically enters into a containment relation with a container through a method of the container called “add.”

A typical GUI component has one or more attributes that define particular properties of the component. For example, a “button” component in a typical windowing GUI will have attributes that define the size of the button on the display, the text or graphics displayed on the face of the button, the background color of the button, a keyboard shortcut associated with the button, and the like. In general, the portion of program code (e.g., function, method, subroutine, procedure, etc.) that instantiates a GUI component will also contain a number of lines of code that set the attributes for that component to desired values. In the JAVA™ programming language and other object-oriented programming systems, for example, components generally have methods that can be executed to set particular attributes of the component.

In many instances it would be helpful to be able to record inputs (e.g., from the keyboard and/or mouse) to GUIs so that these inputs can be saved and replayed. For example, the ability to record and playback input events would increase the efficiency of repetitive GUI testing. In many GUI toolkits, such as the Eclipse Standard Widget Toolkit (SWT) or the JAVA™ AWT/Swing API, there is no facility for assigning persistent unique identities to GUI components. Thus, each time the GUI is recreated (such as in subsequent runs of a GUI application) the GUI controls are given new identities. This makes it difficult to persistently save inputs for subsequent playback as there is no obvious way to remember which control a particular input event is targeted for in a persistent way.

U.S. Published Patent Application 20050091510 (MC KEON et al.) Apr. 28, 2005 provides one method of creating persistent identifiers. That method, however, requires the creation of lengthy and complex path identifiers to preserve uniqueness of identifiers.

What is needed, therefore, is a simple and transparent method for uniquely identifying GUI elements in a persistent manner for subsequent playback of recorded events. The present invention provides a solution to this and other problems, and offers other advantages over previous solutions.

### SUMMARY OF THE INVENTION

The present invention provides a method, computer program product, and data processing system for recording GUI events and for persistently identifying the events' target GUI components for subsequent playback of the recorded events. According to a preferred embodiment of the invention, each GUI component is assigned a numerical identifier by traversing the component hierarchy in a well-defined order (such as a depth-first traversal, for example). As the GUI components are visited during the traversal, the components are numbered sequentially according the order in which the components were visited. When events are received, they are recorded along with the number corresponding to the target component of the event. Upon a subsequent execution of the GUI program, the hierarchy is traversed again in the same order, which associates the same components with the same identifiers as before. Therefore, the recorded events may be played back by applying each event to its corresponding target component, as identified by number.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram of a GUI component hierarchy in accordance with a preferred embodiment of the present invention;

FIG. 2 is a diagram of a modified GUI component hierarchy in accordance with a preferred embodiment of the present invention;

FIG. 3 is a diagram of a renumbered GUI component hierarchy in accordance with a preferred embodiment of the present invention;

FIG. 4 is a diagram of an associative data structure mapping old GUI component identifiers to new GUI component identifiers in accordance with a preferred embodiment of the present invention;

FIG. 5 is a flowchart representation of a process of labeling a GUI component hierarchy in accordance with a preferred embodiment of the present invention;

FIG. 6 is a flowchart representation of a process of recording an event for subsequent playback in accordance with a preferred embodiment of the present invention;

FIG. 7A is a diagram of an array of event records such as might be generated via the process shown in FIG. 6;

FIG. 7B is a diagram of a serialized form of an event record in accordance with a preferred embodiment of the present invention;

FIG. 8 is a flowchart representation of a process of playing back recorded events in accordance with a preferred embodiment of the present invention; and

FIG. 9 is a block diagram of a data processing system in which a preferred embodiment of the present invention may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

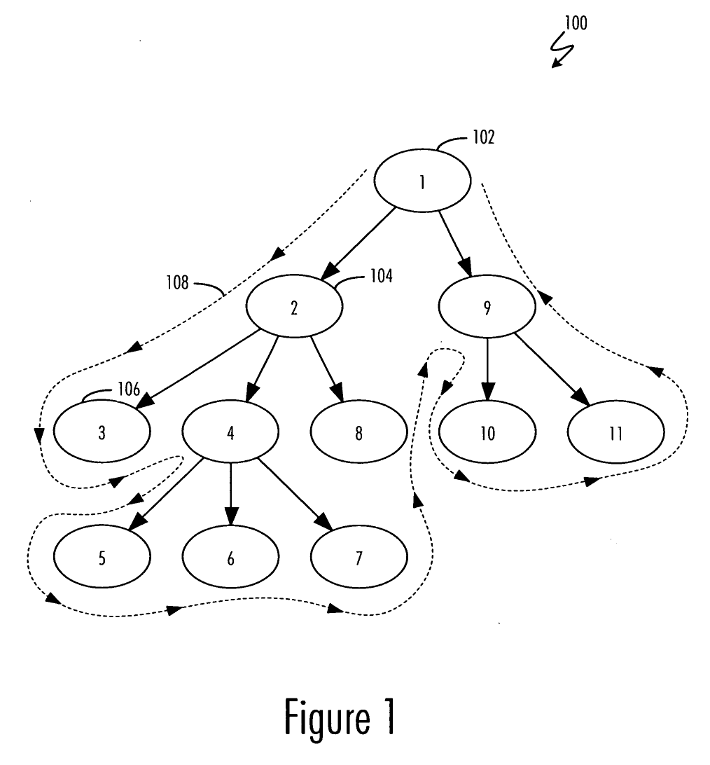

FIG. 1 is a diagram of a GUI component hierarchy 100 in accordance with a preferred embodiment of the present invention. GUI component hierarchy 100 may be implemented in any of a number of GUI toolkits, including, but not limited to, the Eclipse SWT and JAVA™ AWT/Swing APIs. According to this preferred embodiment, each component in hierarchy 100 (e.g., components 102, 104, and 106) is identified using an identifier. In this example, the identifiers chosen are integer numbers, but any similarly enumerable data type may be used for representing the identifiers. These identifier numbers are assigned to the components in hierarchy 100 according to a well-defined ordered traversal process.

In this particular case, the components are numbered according to a left-to-right depth-first traversal (indicated by dashed line 108). Thus, the root element of hierarchy 100, component 102, is numbered “1,” because it is the first component visited in a left-to-right depth-first traversal of hierarchy 100. Similarly, component 104 is the second component visited in a left-to-right depth-first traversal, so it is numbered “2,” component 106 is the third-visited component, so it is numbered “3,” and so on. The resulting labeling of the components in hierarchy 100 is therefore completely determined by the topology of hierarchy 100 and not by any other data (such as other data internal to the components themselves). Thus, this labeling is persistent in the sense that whenever the same hierarchy (with the same topology) is reproduced, the identical labeling can be recreated by performing the same well-defined ordered traversal of the hierarchy.

Further, one skilled in the art will recognize that the specific form of traversal chosen (e.g., depth-first, breadth-first, left-to-right, right-to-left, etc.) is not essential to correct functioning of the invention, provided that the form of traversal that is chosen is one in which there is only one possible order in which the components can be visited for each possible topology. While left-to-right depth-first traversal certainly has this property, there are a myriad of other possible forms of ordered traversal which also have this property.

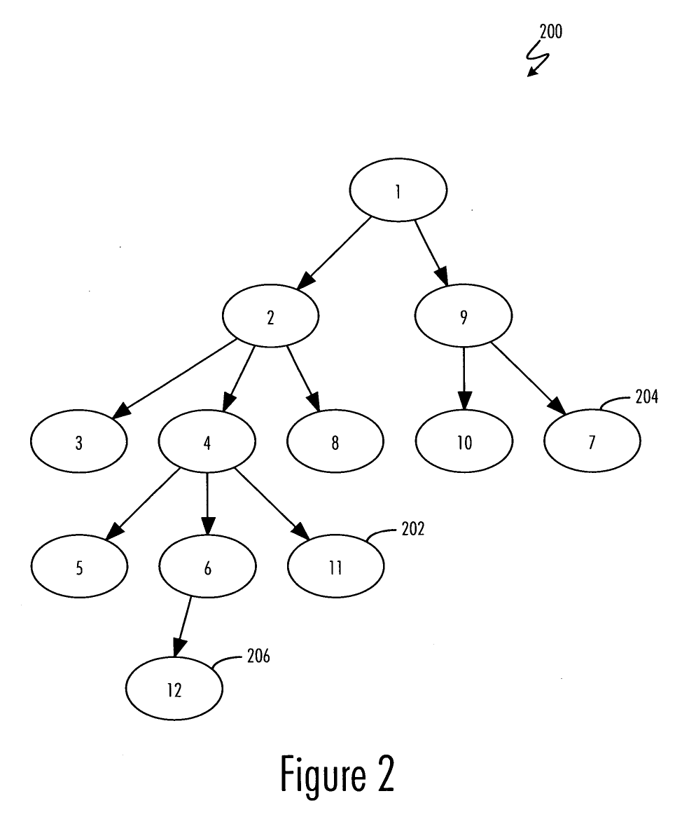

As shown in FIG. 2, once the component hierarchy has been labeled, subsequent modifications can be made to the hierarchy. For example, in FIG. 2, component 202 (labeled “11”) has been exchanged with component 204 (labeled “7”) in modified hierarchy 200 (which is modified from hierarchy 100 in FIG. 1). Also, an additional component 206 has been added to hierarchy 200 and given the identifier “12,” the next numerical identifier in sequence (after 11).

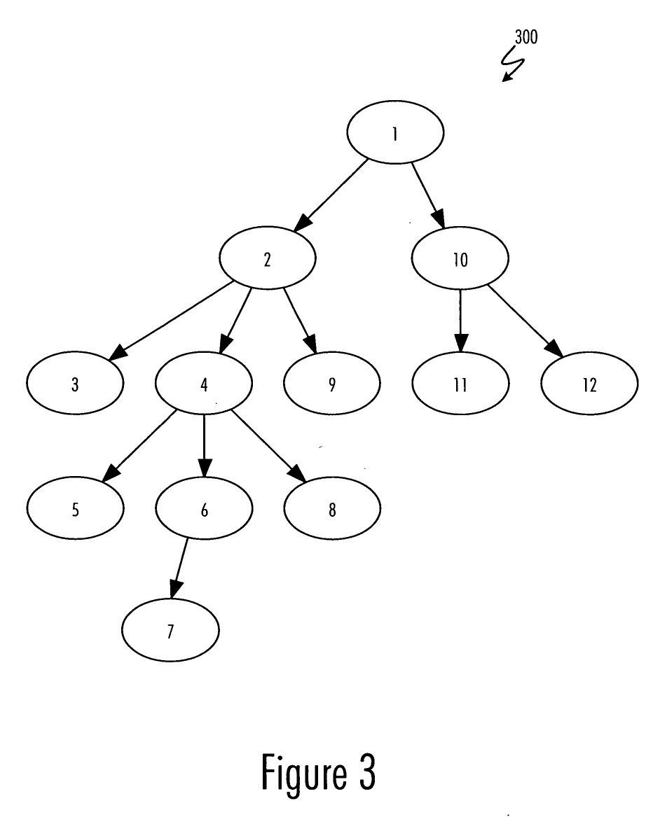

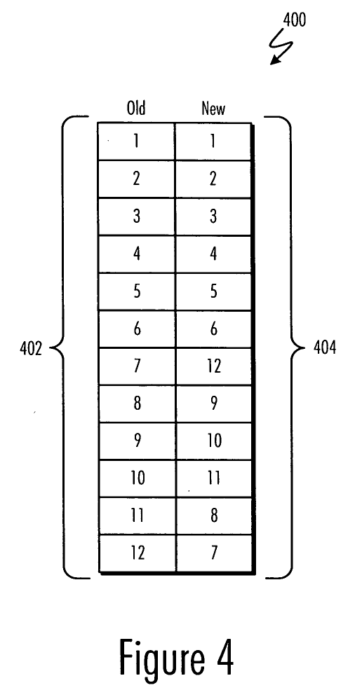

If necessary or if convenient, a component hierarchy, once modified, may be renumbered. For example, FIG. 3 shows a renumbered version 300 of hierarchy 200. When such renumbering occurs, an associative data structure, such as table 400 in FIG. 4 (corresponding to the labelings depicted in FIGS. 2 and 3), may be created in order to map previously-defined identifiers (column 402 in FIG. 4) into corresponding newly-defined identifiers (column 404 in FIG. 4).

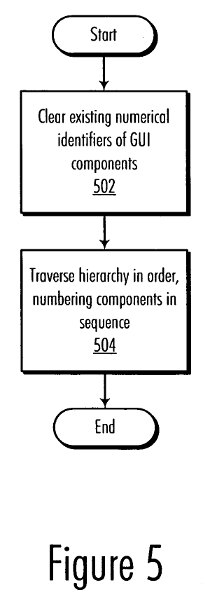

FIGS. 5-8 illustrate processes of creating a labeled hierarchy such as is depicted in FIG. 1, as well as using that hierarchy to identify target components of events so that those events and their corresponding target components may be recorded and played back.

FIG. 5 is a flowchart representation of a process of assigning identifiers to a GUI in accordance with a preferred embodiment of the present invention. This process is executed when the GUI itself is first created, or when a renumbering of the hierarchy is performed, so that the identifiers associated with the components in the hierarchy correctly reflect the current topology of the hierarchy.

When a GUI hierarchy is labeled or re-labeled with identifiers, the GUI components' existing identifiers, if any, are cleared of their current values (block 502). (In the example provided in FIG. 1, these identifiers are numerical identifiers.) The hierarchy is then traversed according to a pre-specified order, and each component is numbered (or otherwise tagged with an identifier) sequentially as the individual GUI components are visited during the traversal (block 504).

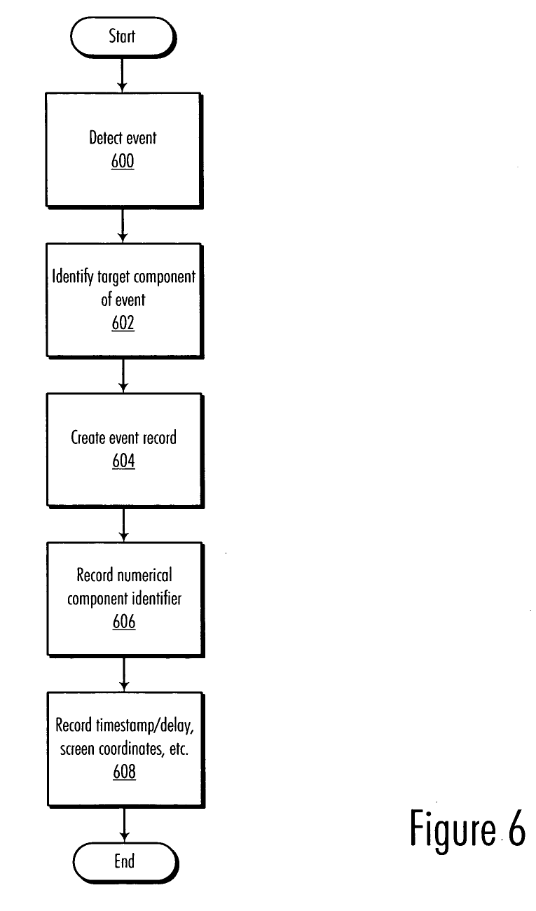

FIG. 6 is a flowchart representation of a process of recording an event for subsequent playback in accordance with a preferred embodiment of the present invention. In a preferred embodiment of the present invention, the process described in FIG. 6 is incorporated into an event handler routine that is called asynchronously whenever an event occurs. When an event is detected (block 600), the target component of the event is detected (block 602).

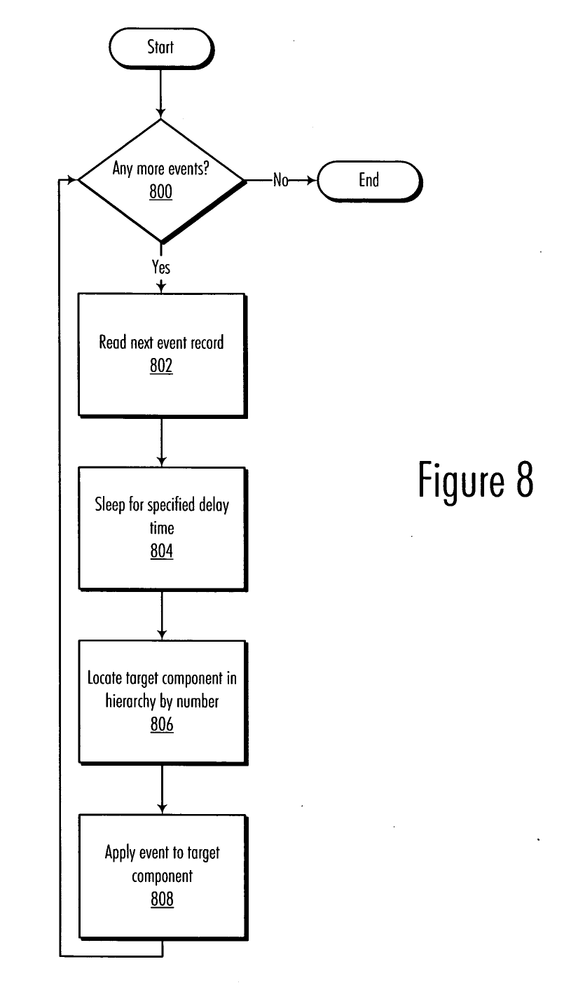

An event record corresponding to the event is then created (block 604). The numerical identifier corresponding to the identified target component is recorded in this event record (block 606). Additional information regarding the event is also stored in the event record (block 608). This information may include the type of event (e.g., keypress, mouse-click, etc.), screen coordinates or other similar parameters corresponding to the event, and timestamp or delay information. This timestamp or delay information is optional information that may be used to recreate the timing of events during playback, such as the amount of time that has elapsed since the last event was recorded. As shown in FIG. 8, this information can be used to interject a measure of delay between the application of recorded events to the GUI.

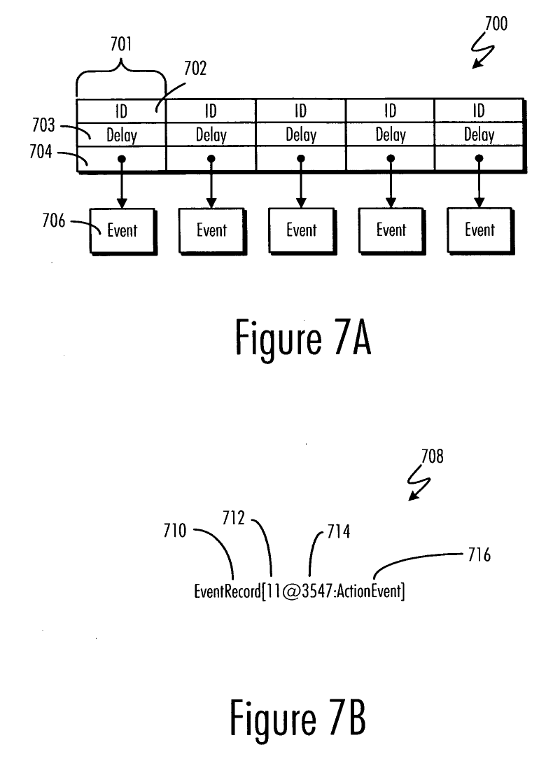

The result of the process described in FIG. 6 is an array 700 of event records (e.g., record 701), as shown in FIG. 7A. Array 700 represents a sequence of recorded events. Each record in array 700 contains the identifier of the GUI component to which the event pertains (identifier 702), the delay time occurring before the event (delay time 703), and a reference or pointer 704 to an event object 706, which is the GUI toolkit's representation of an event, and which contains information regarding the type of event in question.

The information contained in array 700 may be stored in persistent storage for subsequent use. One way in which this may be done in a preferred embodiment of the present invention is to convert each record (e.g., record 701) into a serialized (text) representation 708, as shown in FIG. 7B. Serialized representation 708, an example of how an event record may be serialized, contains a preamble 710, which denotes the beginning of a serialized event record, the identifier of the target component of the event being represented (identifier 712), a delay time 714, and an identification of the type of event represented by the event record (event type 716). One skilled in the art will recognize that a wide variety of different forms of serialization of the event records may be used in an embodiment of the present invention, without limitation and without departing from the scope and spirit of the present invention. Moreover, different amounts of information may be stored/represented in such serializations, depending on the context. For example, a “key press” event might be serialized with additional information regarding the particular key pressed.

Alternatively, other forms of persistent storage may be utilized. Such alternate forms of persistent storage may supplement or replace the serialized/flat-file storage described in FIG. 7B. For example, one could use a relational database or other form of database management system to store the event information.

FIG. 8 is a flowchart representation of a process of playing back recorded events in accordance with a preferred embodiment of the present invention. While there are events to be played back (block 800:yes), the next event record is read (from persistent storage or from memory) (block 802). The current process or thread is then suspended (put to sleep) for the specified amount of delay time recorded in event record (block 804). The number corresponding to the target component of the event is then read from the event record and the corresponding component is located by traversing the GUI component hierarchy, as shown in FIG. 1 (block 806). The recorded event is then applied to the identified target component (block 808). This process is repeated until there are no more events to be played back (block 800).

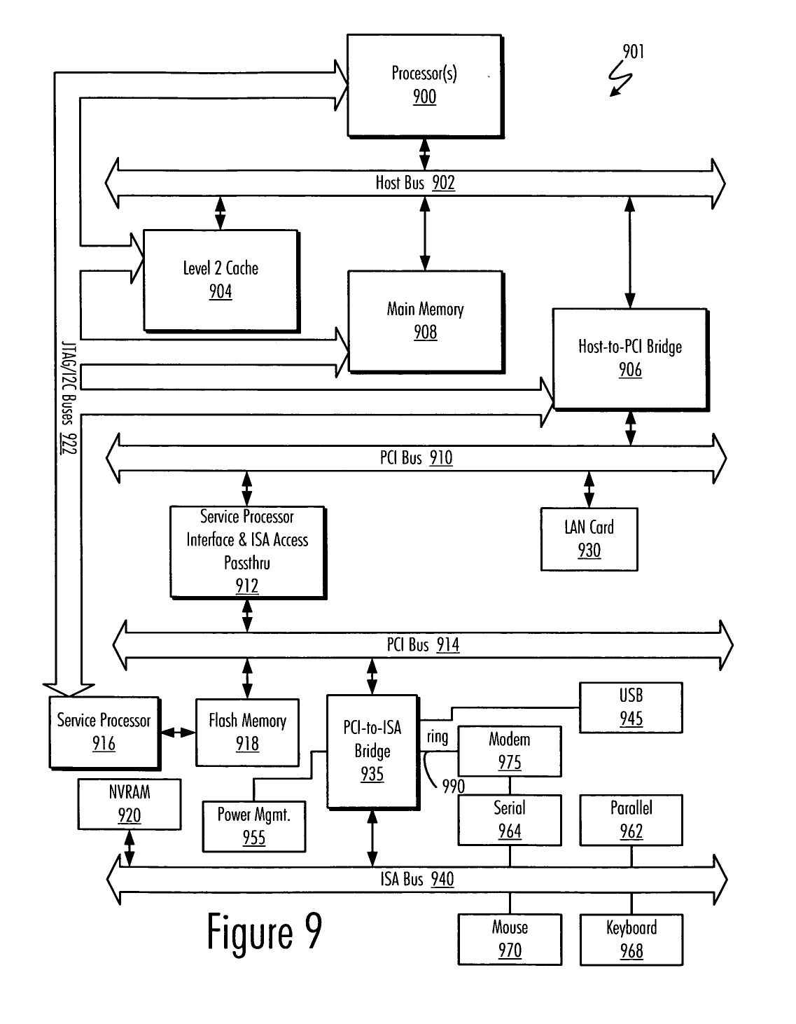

FIG. 9 illustrates information handling system 901 which is a simplified example of a computer system/server capable of performing the computing operations described herein with respect to a preferred embodiment of the present invention. Computer system 901 includes processor 900 which is coupled to host bus 902. A level two (L2) cache memory 904 is also coupled to host bus 902. Host-to-PCI bridge 906 is coupled to main memory 908, includes cache memory and main memory control functions, and provides bus control to handle transfers among PCI bus 910, processor 900, L2 cache 904, main memory 908, and host bus 902. Main memory 908 is coupled to Host-to-PCI bridge 906 as well as host bus 902. Devices used solely by host processor(s) 900, such as LAN card 930, are coupled to PCI bus 910. Service Processor Interface and ISA Access Pass-through 912 provides an interface between PCI bus 910 and PCI bus 914. In this manner, PCI bus 914 is insulated from PCI bus 910. Devices, such as flash memory 918, are coupled to PCI bus 914. In one implementation, flash memory 918 includes BIOS code that incorporates the necessary processor executable code for a variety of low-level system functions and system boot functions.

PCI bus 914 provides an interface for a variety of devices that are shared by host processor(s) 900 and Service Processor 916 including, for example, flash memory 918. PCI-to-ISA bridge 935 provides bus control to handle transfers between PCI bus 914 and ISA bus 940, universal serial bus (USB) functionality 945, power management functionality 955, and can include other functional elements not shown, such as a real-time clock (RTC), DMA control, interrupt support, and system management bus support. Nonvolatile RAM 920 is attached to ISA Bus 940. Service Processor 916 includes JTAG and I2C buses 922 for communication with processor(s) 900 during initialization steps. JTAG/I2C buses 922 are also coupled to L2 cache 904, Host-to-PCI bridge 906, and main memory 908 providing a communications path between the processor, the Service Processor, the L2 cache, the Host-to-PCI bridge, and the main memory. Service Processor 916 also has access to system power resources for powering down information handling device 901.

Peripheral devices and input/output (I/O) devices can be attached to various interfaces (e.g., parallel interface 962, serial interface 964, keyboard interface 968, and mouse interface 970 coupled to ISA bus 940. Alternatively, many I/O devices can be accommodated by a super I/O controller (not shown) attached to ISA bus 940.

In order to attach computer system 901 to another computer system to copy files over a network, LAN card 930 is coupled to PCI bus 910. Similarly, to connect computer system 901 to an ISP to connect to the Internet using a telephone line connection, modem 975 is connected to serial port 964 and PCI-to-ISA Bridge 935.

While the computer system described in FIG. 9 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

What is claimed is:

1. A computer-implemented method comprising:
assigning identifiers to a plurality of components in a graphical user interface component hierarchy according to an ordered traversal of the hierarchy;
detecting an event;
recording the event with a corresponding identifier of a target component associated with the event.

2. The method of claim 1, wherein the ordered traversal of the hierarchy is a depth-first traversal.

3. The method of claim 1, wherein the identifiers are numerical identifiers.

4. The method of claim 1, wherein the event is recorded along with a delay amount corresponding to an amount of time having elapsed since a preceding event.

5. The method of claim 1, wherein the event is recorded in persistent storage.

6. The method of claim 1, further comprising:
playing back the recorded event by recreating the recorded event with respect to the target component, wherein the target component is identified using the recorded identifier.

7. The method of claim 1, further comprising:
modifying the component hierarchy to obtain a modified hierarchy; and
assigning new identifiers to the plurality of components according to an ordered traversal of the modified hierarchy.

8. The method of claim 7, further comprising:
generating an associative data structure defining a mapping into the new identifiers.

9. The method of claim 1, further comprising:
adding an additional component to the component hierarchy; and
in response to adding the additional component, assigning a next identifier to the additional component, wherein the next identifier sequentially follows a last identifier already assigned.

10. A computer program product in a computer-readable medium, comprising functional descriptive material that, when executed by a computer, directs the computer to perform actions of:
assigning identifiers to a plurality of components in a graphical user interface component hierarchy according to an ordered traversal of the hierarchy;
detecting an event; and
recording the event with a corresponding identifier of a target component associated with the event.

11. The computer program product of claim 10, wherein the ordered traversal of the hierarchy is a depth-first traversal.

12. The computer program product of claim 10, wherein the identifiers are numerical identifiers.

13. The computer program product of claim 10, wherein the event is recorded along with a delay amount corresponding to an amount of time having elapsed since a preceding event.

14. The computer program product of claim 10, wherein the event is recorded in persistent storage.

15. The computer program product of claim 10, comprising additional functional descriptive material that, when executed by the computer, directs the computer to perform actions of:
playing back the recorded event by recreating the recorded event with respect to the target component, wherein the target component is identified using the recorded identifier.

16. A data processing system comprising:
at least one processor;
storage associated with the at least one processor; and
a set of instructions in the storage, wherein the at least one processor executes the set of instructions to perform actions of:
assigning identifiers to a plurality of components in a graphical user interface component hierarchy according to an ordered traversal of the hierarchy;
detecting an event; and
recording the event with a corresponding identifier of a target component associated with the event.

17. The data processing system of claim 16, wherein the event is recorded along with a delay amount corresponding to an amount of time having elapsed since a preceding event.

18. The data processing system of claim 16, wherein the event is recorded in persistent storage.

19. The data processing system of claim 16, wherein the at least one processor executes the set of instructions to perform actions of:
playing back the recorded event by recreating the recorded event with respect to the target component, wherein the target component is identified using the recorded identifier.

20. The data processing system of claim 16, wherein the at least one processor executes the set of instructions to perform actions of:
modifying the component hierarchy to obtain a modified hierarchy; and
assigning new identifiers to the plurality of components according to an ordered traversal of the modified hierarchy.
